(19) United States
(12) Patent Application Publication
(10) Pub. No.: US 2018/0346793 A1
(43) Pub. Date: Dec. 6, 2018

(54) LOW-DENSITY GELS AND COMPOSITES FOR PROTECTING UNDERGROUND ELECTRIC COMPONENTS FROM CHEMICAL DAMAGE

(71) Applicant: Saudi Arabian Oil Company, Dhahran (SA)

(72) Inventors: Ghanem H. Al-Zoraia, Dhahran (SA); Weishu Zhao, Dhahran (SA); Jin Huang, Dhahran (SA); Fakuen Frank Chang, Dhahran (SA); Feng Liang, Cypress, TX (US); Rajendra Arunkumar Kalgaonkar, Abqaiq (SA)

(73) Assignee: Saudi Arabian Oil Company, Dhahran (SA)

(21) Appl. No.: 15/992,765

(22) Filed: May 30, 2018

Related U.S. Application Data
(60) Provisional application No. 62/514,067, filed on Jun. 2, 2017.

(51) Int. Cl. C09K 8/536; C09K 8/54; C08L 75/02

(52) U.S. Cl. CPC C09K 8/536; C08K 3/36; C08L 75/02; C09K 8/54

(57) ABSTRACT

Materials and methods for protecting electric cables and connectors from corrosive atmospheres and chemicals, particularly in oil wells, are provided herein.

### CLAIM OF PRIORITY

This application claims the benefit of U.S. Provisional Application No. 62/514,067, filed Jun. 2, 2017. The entire contents of the foregoing are incorporated by reference.

### TECHNICAL FIELD

This disclosure relates to materials and methods for protecting metal components, including electric cables and connectors, from corrosive atmospheres and chemicals encountered underground (for example, in an oil well).

### BACKGROUND

Electric Submersible Pumps (ESP) are commonly used artificial lift equipment in oil production wells. ESP packer penetrator systems are used to carry an electric power cable from the surface control panel to the electric motor of an ESP within the wellbore. Due to the presence of various chemicals downhole, however, the metal wires and insulation materials for the electric connectors of the power cable often are exposed to highly corrosive and hostile environments. In fact, many ESP failures can be attributed to packer penetrator failure, due to corrosion of the electric connector beneath the ESP packer.

### SUMMARY

This specification describes materials and methods for prolonged protection of electric connectors from corrosive atmospheres and chemicals. As described in this document, for example, methods have been developed to generate low-density gel/composite systems that can be used to isolate electric connectors and wires from downhole chemicals. For example, a mixture of low-density polymeric materials or composites can be prepared on the surface and then pumped, possibly with a carrier fluid, through bypass tubing to the vicinity of the underground motor. The low density of the mixture can allow it to travel upward in the wellbore and float on the top of downhole fluids. Under high temperature in the wellbore, or upon exposure to oil, or a particular pH, or a particular chemical or combination of chemicals, the mixture can form a rigid gel or composite. The gel or composite can serve as a barrier between the electric connector and the downhole fluids, isolating the electric connector and protecting it from the hostile environment. In some cases, the mixture can form a gel that is soft enough to permit future ESP retrieval.

In one aspect, this document features a method for making a low-density gel or composite. The method can include combining a polymeric material and a low-density material to form a mixture, and exposing the mixture to conditions sufficient to cause the mixture to form a gel or composite that is impermeable to crude oil. The density of the gel or composite can be less than 790 kilograms per cubic meters (kg/m³). The polymeric material can contain an oil-swellable elastomer, and the exposing step can include contacting the mixture with oil (for example, crude oil in a well). The oil-swellable elastomer can include, but are not limited to, one or more of acrylonitrile-butadiene rubber (NBR), hydrogenated nitrile butadiene rubber (HNBR), ethylene propylene diene monomer rubber (EPDM), polystyrene, styrene-divinylbenzene copolymer, and silicone. The oil-swellable elastomer can be in a mixture or dispersion form in an aqueous-based fluid (for example, water). The mixture can further contain a foaming surfactant (for example, one or more of sodium dodecyl sulfate, cocamidopropyl hydroxysultaine, a primary alcohol ethoxylate (PAE) surfactant, an alkylphenol ethoxylate (APE) surfactant, a secondary alcohol ethoxylate (SAE), a nonylphenol ethoxylate (NPE), an octylphenol ethoxylate (OPE), or an ethylene oxide/propylene oxide (EO/PO) copolymer). The polymeric material can include a crosslinked polymer. The polymeric material can include a crosslinkable polymer, and the exposing step can include contacting the mixture with a crosslinking agent or exposing the mixture to heat (for example, a temperature between 150 Fahrenheit (° F.) and 450° F.) to generate a crosslinked polymer. The crosslinked polymer can include one or more of guar, hydroxypropyl guar (HPG), carboxymethyl guar (CMG), carboxymethyl hydroxypropyl guar (CMHPG), polyacrylamide, polyacrylamide copolymers, hydroxyethyl cellulose, and hydroxypropyl cellulose. The polymeric material can include a curable resin, and the exposing can include contacting the curable resin with a curing agent. The curable resin can include one or more of an epoxy resin, a phenolic resin, or a furan resin. The polymeric material can include an oil-soluble polymer, and the exposing step can include contacting the mixture with oil (for example, crude oil in a well). The oil-soluble polymer can include one or more of polystyrene, polydimethylsiloxane, and polymers containing one or more functional groups (for example, ketones or aldehydes). The polymeric material can include polyurea or a polyurea-based agent, and the exposing step can include exposing the mixture to a temperature of about 150° F. The low-density material in any of the previous embodiments can be include rigid spheres (for example, microbubbles, such as glass microbubbles). In some cases, one or more polymeric materials (for example, an oil-soluble polymer, an oil-swellable elastomer, or an oil-soluble polymer and an oil-swellable elastomer) can be fused to or coated on the outer surface of the low-density material. The low-density gel or composite can further include one or more oil-swellable or oil-soluble polymers fused to or coated on its outer surface.

In another aspect, this document features a method for making a low-density gel or composite, where the method includes combining colloidal nanosilica and a low-density material to form a mixture, and exposing the mixture to salt or to a pH less than 7, such that the mixture to forms a gel or composite. The density of the gel or composite can be less than 790 kg/m³. The low-density material can include rigid spheres (for example, microbubbles, such as glass microbubbles). The colloidal nanosilica can be fused to or coated on the outer surface of the microbubbles.

In another aspect, this document features a method for generating a gel or composite composition adjacent to a packer penetrator within an oil well. The method can include placing a polymeric material into the well at or about the location of an electrical component of the packer penetrator, and exposing the polymeric material to form a gel or composite that separates the electrical component from oil in the well. The density of the gel or composite can be less than 790 kg/m³. The polymeric material can include an oil-swellable elastomer, and the exposing step can include contacting the oil-swellable polymer with the oil. The oil-swellable elastomer can include one or more of NBR, HNBR, EPDM, polystyrene, styrene-divinylbenzene copolymer, and silicone. The oil-swellable elastomer can be in a mixture or dispersion in water. The mixture can further contain a foaming surfactant (for example, one or more of sodium dodecyl sulfate, cocamidopropyl hydroxysultaine, a PAE surfactant, an APE surfactant, a SAE, a NPE, an OPE, or an EO/PO copolymer). The polymeric material can include a crosslinked polymer. The polymeric material can include a crosslinkable polymer, and the exposing step can include contacting the crosslinked polymer with a crosslinking agent or exposing the crosslinked polymer to heat (for example, a temperature between 150° F. and 450° F.). The crosslinked polymer can include one or more of guar, HPG, CMG, CMHPG, polyacrylamide or polyacrylamide copolymers, hydroxyethyl cellulose, and hydroxypropyl cellulose. The polymeric material can include a curable resin, and the exposing step can include contacting the curable resin with a curing agent. The curable resin can include one or more of an epoxy resin, a phenolic resin, or a furan resin. The polymeric material can include an oil-soluble polymer, and the exposing step can include contacting the oil-soluble polymer with the oil. The oil-soluble polymer can include one or more of polystyrene, polydimethylsiloxane, and polymers containing one or more functional groups (for example, ketones or aldehydes). The polymeric material can include polyurea or a polyurea-based agent, and the exposing step can include exposing the polyurea to a temperature of about 150° F. The polymeric material can be in a composition with a low-density material when it is placed in the well. The low-density material can include rigid spheres (for example, microbubbles, such as glass microbubbles). The polymeric material can be fused to or coated on the outer surface of the low-density material. In some cases, one or more polymeric materials (for example, an oil-soluble polymer, an oil-swellable elastomer, or an oil-soluble polymer and an oil-swellable elastomer) can be fused to or coated on the outer surface of the low-density material. The low-density gel or composite can further include one or more oil-swellable or oil-soluble polymers fused to or coated on its outer surface.

In still another aspect, this document features a method for generating a gel or composite composition adjacent to a packer penetrator within an oil well. The method can include placing colloidal nanosilica into the well at or about the location of an electrical component of the packer penetrator, and exposing the colloidal nanosilica to salt or a pH less than 7 such that it forms a gel or composite that separates the electrical component from oil in the well. The density of the gel or composite can be less than 790 kg/m³. The colloidal nanosilica can be in a composition with a low-density material. The low-density material can include rigid spheres (for example, microbubbles, such as glass microbubbles) when it is placed in the well. The colloidal nanosilica can be fused to or coated on the outer surface of the low-density material.

This document also features a composition containing colloidal silica, an activator, and hollow glass microspheres (HGMs). The density of the composition can be less than 790 kg/m³. The colloidal silica can include a nanosilica. The activator can include a salt or a solution with a pH less than 7 (for example, 6 to 6.9, 5 to 6, 4 to 5, or less than 4). The HGMs can be present in the composition at a weight percentage of about 10% to about 70%. The density of the composition can be about 0.1 to 0.8 grams per cubic centimeter (g/cc).

In addition, this document features a composition containing an oil-swellable polymer, HGMs, and a fluid carrier. The oil-swellable polymer can include one or more of NBR, HNBR, EPDM, polystyrene, styrene-divinylbenzene copolymer, and silicone. The fluid carrier can include water or diesel. The HGMs can be present in the composition at a weight percentage of about 10 percent (%) to about 70%. The density of the composition can be about 0.1 to 0.8 g/cc.

The details of one or more implementations of the subject matter described in this specification are set forth in the accompanying drawings and the description later. Other features, aspects, and advantages of the subject matter will become apparent from the description, the drawings, and the claims.

### DESCRIPTION OF DRAWINGS

FIG. 1 is a diagram illustrating an ESP with a packer penetrator system carrying an electric cable from a surface controller to the motor of an ESP.

FIG. 2 is an image showing a low-density PLENCO® resin composite (Plastics Engineering Company, Sheboygan, Wis.) sitting on the top of a layer of hexanes. The bottom layer of fluid is water.

FIG. 3 is a pair of microscopic images showing PLIOLITE® (synthetic polymers also referred to as Pexotrol from Omnova Solutions; Fairlawn, Ohio) before expansion (left panel) and after expansion (right panel). The expanded polymer formed a gel.

FIG. 4 is an image showing a paste generated by mixing a PLIOLITE® polymer with water and micro glass bubbles.

FIG. 5 is an image showing a drop of the composite paste floating on the surface of diesel.

FIG. 6 is an image showing the composite on top of the diesel after heating, which generated a composite plug that sealed the fluids beneath.

FIG. 7 is an image showing a low-density composite formed from combining EXPANCEL® DE hollow polymer bubbles (AkzoNobel, Sundsvall, Sweden) with PLIOLITE® DF01 vinyl toluene acrylic copolymer resin gel (Omnova Solutions; Fairlawn, Ohio) and diesel. The mixture was lighter than diesel and formed a seal after heating.

### DETAILED DESCRIPTION

ESP systems such as those used in oil production wells typically include a packer penetrator that carries an electric power cable from a control panel at the surface to an electric motor underground, at or near the location of the oil. Due to the presence of various chemicals downhole, however, the wires and insulation materials for the electric connectors of the power cable can be exposed to corrosive conditions and hostile environments. ESP failures often can be attributed to packer penetrator failure due to corrosion of the electric connector downhole of the ESP packer. In fact, about 30% of ESP failure results from the loss of electric contact in the ESP packer penetrator connection, leading to expensive repairs and workovers.

This disclosure provides materials and methods for isolating the electric wires and connectors of an ESP system from corrosive reservoir fluids and gases, which can significantly lengthen ESP run life. In particular, this disclosure describes the use of fluid polymeric materials to form an impermeable, rigid, solid mass (for example, a gel or composite) that can insulate ESP packer penetrator connections from well fluid and gas downhole of production packers. The materials typically are less dense than crude oil, and therefore float uphole above the static oil column in the annulus between the casing and production tubing. The term “low-density” as used in this document refers to a density less than that of crude oil. Crude oil typically has a density of about 790 kg/m³ (for “light” crude oil) to about 970 kg/m³ (for “heavy” crude oil), depending on the amount of hydrocarbons in the oil. Thus, the low-density gels, composites, and components described in this document can have a density that is less than about 970 kg/m³ (for example, less than about 900 kg/m³, less than about 850 kg/m³, less than about 800 kg/m³, less than about 790 kg/m³, or less than about 750 kg/m³). The density of the gel or composite that is used can be based on the type of crude oil that is present in the well in which the gel or composite is to be placed. Once a low-density composition reaches the vicinity of an ESP packer penetrator in a well, the material can be triggered to crosslink to gel or solidify by chemical or thermal mechanisms.

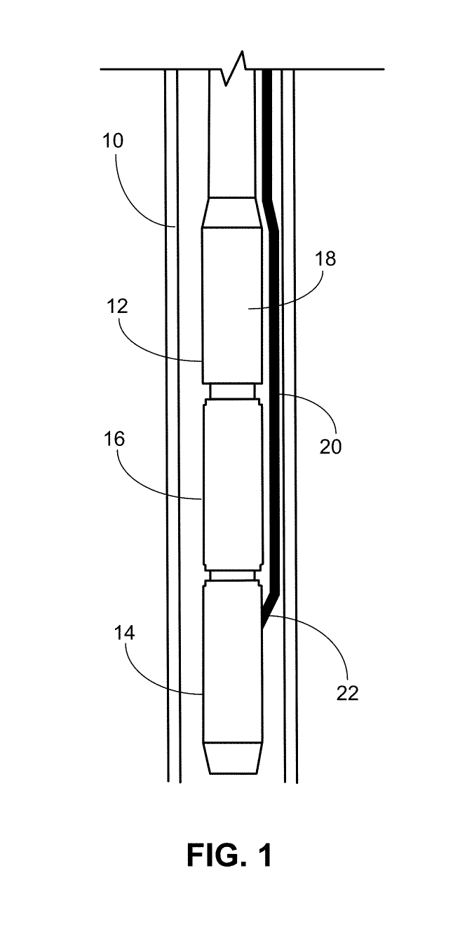

A basic depiction of an ESP is illustrated in FIG. 1, which shows a well 10 containing an ESP 12 for pumping fluids from within the well 10 to the surface. ESP 12 includes an electric motor 14, and a seal section 16 uphole of motor 14. Seal section 16 seals well fluid from entry into motor 14. ESP 12 also includes a pump section that includes pump assembly 18 located uphole of seal section 16. In addition, a power cable 20 extends alongside ESP 12, terminating in a connector 22 that electrically couples cable 20 to motor 14.

The materials and methods described in this specification can be used to protect electric cables and connectors, such as cable 20 and connector 22 of an ESP device as shown in FIG. 1, from damage caused by the fluids and gasses within an oil well. In some cases, a gel or composite can be generated as a sealing mechanism for isolating an electric connection from reservoir fluids and gasses. For example, a fluid composition containing a polymer that swells when it comes into contact with oil can be used to form a gel under wellbore conditions. As another example, a crosslinked or crosslinkable polymer (for example, guar, HPG, CMG, CMHPG, polyacrylamide or polyacrylamide copolymers, hydroxyethyl cellulose, and hydroxypropyl cellulose), or a compound such as colloidal silica, can be placed at about the position of an ESP packer penetrator within the well and then, if needed, crosslinked through thermal or chemical means to form a gel. Suitable crosslinking agents typically are determined based on the crosslinkable polymer or polymers used. For example, guar-based materials can be crosslinked with borate-based or metal crosslinkers (for example, Zr-, Cr- or Ti-based crosslinkers). Acrylamide-based polymers can be crosslinked with amines or metal crosslinkers (for example, Zr-, Cr-, or Ti-based crosslinkers). Cellulose-based polymers also can be crosslinked with metal crosslinkers (Zr-, Cr-, or Ti-based crosslinkers). In some cases, when a swellable or crosslinkable polymer is used in an oil well to form a protective barrier for ESP components, the polymer itself can have a low density as described in this document, such that its density is less than the density of the crude oil in the well (less than about 970 kg/m³, less than about 900 kg/m³, less than about 850 kg/m³, less than about 800 kg/m³, less than about 790 kg/m³, or less than about 750 kg/m³). Thus, in some cases, polymers (for example, polyethylene, including low-density polyethylene) with a density that is not less than the density of crude oil may be not suitable for use in the methods described in this document.

In some cases, the density of a composition containing a polymer (for example, an oil-swellable, crosslinked, or crosslinkable polymer) or another component capable of forming a gel or composite can be reduced by adding one or more high-strength, light-weight fillers to the composition. The one or more fillers can give the composition a density less than that of crude oil. For example, microspheres or “microbubbles” formed from hollow glass or polymer spheres that are filled with gas at atmospheric pressure or at reduced pressure (for example, EXPANCEL® microbubbles from AkzoNobel, or HGS19K46 Glass Bubbles from 3M®, St. Paul, Minn.) can be included in the compositions described in this document, and can make the compositions more buoyant than crude oil. Thus, in some cases, the compositions used in the methods described in this document can include hollow glass microspheres (HGMs) with an oil-based polymer fused onto their outer surface. In some cases, the compositions can include HGMs in combination with a colloidal silica (for example, a colloidal nanosilica) that can be triggered to crosslink when the pH is reduced to a pH less than 7 or when salt is added. For example, glass microspheres and colloidal silica can be combined with an activator such as a salt or chemical that can lower pH to trigger cross-linking of the silica, and the resulting fluid or slurry can be injected into a well. The pH reducing agent can include an acid or an ester such as, without limitation, hydrochloric acid (HCl), an organic acid, or sodium acetate. The buoyancy conferred by the glass spheres can cause the mixture to rise uphole, above the oil in the column. Other low-density components also can be used, including particles in the form of small spheres, beads, or chunks of material. In some cases, the low-density components can have an average diameter or width of 3 millimeters (mm) or less (for example, 2.5 mm or less, 2 mm or less, 1.5 mm or less, 1 mm or less, 2 to 3 mm, 1 to 2 mm, 500 micrometers (μm) to 1 mm, 250 to 500 μm, 100 to 250 μm, 50 to 100 μm, or 10 to 50 μm).

The density of HGS series glass bubbles typically is about 0.1 to 0.6 g/cc, and that the density of the compositions used in the methods described in this document can be adjusted based on the percentage of added glass bubbles. The weight percentage of the glass bubbles in a composite can be from about 1% to about 99% (for example, about 1 to 5%, 5 to 10%, 10 to 20%, 20 to 30%, 30 to 40%, 40 to 50%, 50 to 60%, 60 to 70%, 70 to 80%, 80 to 90%, 90 to 99%, 1 to 20%, 10 to 25%, 10 to 70%, 20 to 50%, 25 to 50%, 50 to 75%, 75 to 80%, or 80 to 95%). The percentage of glass bubbles in a composition may be chosen based on the density of the other materials in the composition. The final density of the compositions provided by this document typically can be from about 0.1 to 0.8 g/cc (for example, 0.1 to 0.2 g/cc, 0.2 to 0.3 g/cc, 0.3 to 0.5 g/cc, 0.5 to 0.7 g/cc, or 0.7 to 0.8 g/cc).

In some cases, a curable resin system (for example, an epoxy resin, a phenolic resin, or a furan resin) can be used to protect ESP packer penetrator electric cables and connectors from downhole chemicals. For example, a curable resin can be mixed with HGMs and one or more curing agents. The mixture can be delivered to a well as a pallet or in sphere form with a certain size (typically less than a few millimeters, such 3 mm or less, 2.5 mm or less, 2 mm or less, 1.5 mm or less, or 1 mm or less). Suitable curing agents include, but are not limited to, diethylenetriamine (DTA), diethylaminopropylamine (DEAPA), N-aminoethylpiperazine (N-AEP), isophoronediamine (IPDA), diaminodiphenylsulfone (DDS), diaminodiphenylmethane (DDM) for epoxy resins, and hexamethylenetetramine for phenolic resins. When the light-weight curable resin composition is pumped to the area of an ESP packer penetrator in a well (for example, using coiled tubing) and reaches wellbore temperature, the resin can be cured to form a block around the electric connector. In some cases, the stiffness of the final resin can be tailored based on the curing agent or agents included in the curable system.

In some cases, oil-swellable rubbers or elastomers can be used. The degree of swell typically is dependent on the fluid conditions and elastomer type and design. Examples of useful oil-swellable rubbers include, but are not limited to, acrylonitrile-butadiene rubber (NBR), hydrogenated nitrile butadiene rubber (HNBR), ethylene propylene diene monomer rubber (EPDM), polystyrene, styrene-divinylbenzene copolymer, and silicone (for example, polydimethylsiloxane). One or more oil-swellable elastomers can be blended with HGMs and delivered to a well either as a pallet or sphere form with a certain size (typically less than a few millimeters; for example, less than 3 mm, less than 2 mm, or less than 1 mm) by pumping the mixture to the area of an ESP packer penetrator (for example, using coiled tubing). When exposed to oil in the wellbore, the lightweight elastomer composition can swell to occupy the empty spaces around the electric connector. During preparation, the low-density oil-swellable rubber can be ground to a particle size between about 0.1 micron and about 100 microns (for example, about 1 to 50 microns, about 2 to 40 microns, or about 3 to 30 microns). The solid rubber then can be mixed with water and emulsified to form a water-in-oil emulsion slurry. The slurry can be further formed by adding a foaming surfactant (for example, sodium dodecyl sulfate, cocamidopropyl hydroxysultaine, a primary alcohol ethoxylate (PAE) surfactant, an alkylphenol ethoxylate (APE) surfactant, a secondary alcohol ethoxylate (SAE), a nonylphenol ethoxylate (NPE), an octylphenol ethoxylate (OPE), or an ethylene oxide/propylene oxide (EO/PO) copolymer) to further reduce the density. The slurry then can be injected into an oil well such that it floats uphole from the oil column in the annulus. Once the emulsion breaks and the water phase sinks, the oil-swellable rubber particles will be exposed to the oil, causing them to expand and form a tight packing in the annulus to isolate the space around the seal.

In some cases, one or more oil-soluble or oil-swellable polymers can be attached to or coated on the outer surface of HGMs by physical adsorption or chemical bonding. For example, the outer surface of glass spheres can include hydroxyl or amine terminal groups to which a polymer can be coupled by chemical reaction. In some cases, the outer surface of hollow glass beads can be pre-treated with sodium hydroxide, hydrochloric acid, or sulfuric acid, with or without a silane coupling agent such as 3-aminopropyltriethoxysilane (Sinopharm Chemical Reagent Co., Ltd., China), to enhance polymer attachment. The polymer-coated, low-density HGMs can be injected into an oil well, where they can float to the top of the fluid column in the well annulus between the production tubing and casing. The coating material (the oil-soluble or oil-swellable polymer) can then expand to form a rigid and non-permeable gel that provides a seal between the reservoir fluid in the well annulus and the production packer. In some cases, low-density, oil-swellable elastomer composite particles can be formed by coating a low-density, rigid material (for example, microbubbles) with one or more oil-swellable elastomers. The low-density, oil-swellable elastomer composite particles may be further coated with an oil-soluble polymer, which can delay the swelling process during deployment of the composite into an oil well. Useful oil-soluble polymers include, but are not limited to, polystyrene, polydimethylsiloxane (PDMS), and polymers containing functional groups such as ketones and aldehydes. Examples of polymers containing aldehyde groups include, but are not limited to, unsaturated aliphatic aldehydes. In some cases, the polymer can include one or more of acrolein, methacrolein, a beta-formal acrylic acid ester, a maleic di-aldehyde, or a fumaric di-aldehyde. Examples of suitable polymers containing ketone groups include, for example, unsaturated aliphatic ketones.

In some cases, a composition also can include polyurea or a polyurea-based compound, which can act as a thickening agent to form a shear-sensitive gel that isolates the ESP from reservoir fluids and gasses. The thickening agent can be a polymer containing urea linkages or urea and urethane linkages. Suitable, non-limiting examples of methods for forming a polymer containing urea or urea and urethane linkages include the following.

In some cases, for example, a polymer containing urea linkages can be formed from the combination of a compound containing two or more isocyanate functional groups and a compound containing two or more amine functional groups, by (1) polymerizing a first monomer of di-isocyanate and a second monomer of diamine; (2) forming a pre-polyisocyanate and then polymerizing the pre-polyisocyanate with a final monomer of diamine; (3) forming a pre-polyamine and then polymerizing the pre-polyamine with a monomer of di-isocyanate; or (4) forming a pre-polyisocyanate and a pre-polyamine and then polymerizing both of the pre-polymers.

In some cases, a polymer containing urea and urethane linkages can be formed from a compound with two or more isocyanate functional groups, a compound with two or more amine functional groups, a compound with two or more hydroxyl functional groups, or a compound with combinations of isocyanate, amine, and hydroxyl functional groups. The polymer containing urea and urethane linkages can be generated by (1) polymerizing a monomer of di-isocyanate with a mixture of the monomers diol and diamine; (2) forming a pre-polyurethane and then polymerizing the pre-polyurethane with a monomer of diamine; (3) forming a polyisocyanate, polyamine, or polyol pre-polymer and then polymerizing the pre-polymer with the remaining monomers that contain the necessary functional groups (for example, forming a pre-polyamine and then polymerizing the pre-polyamine with a mixture of monomers containing diol and diamine); or (4) forming more than one pre-polymer and then polymerizing all of the pre-polymers, plus any remaining monomers that contain the necessary functional groups. Any of the compounds containing the necessary functional groups can be a monomer or part of a pre-polymer. The pre-polymer can include more than one of the necessary functional groups. In addition, the polymer and any of the pre-polymers can be natural polymers or synthetic polymers, including resins.

Examples of suitable compounds (for example, monomers or pre-polymers) containing two or more isocyanate functional groups include, but are not limited to, hexamethylene-diisocyanate (HDI); toluene-diisocyanate (TDI); 2,2′-, 2,4′- and 4,4′-diisocyanatodiphenylmethane (MDI); polymethylenepolyphenyl diisocyanate (PMDI); naphthalene-diisocyanate (NDI); 1,6-diisocyanato-2,2,4-trimethylhexane; isophorone-diisocyanate; (3-isocyanato-methyl)-3,5,5-trimethyl cyclohexyl isocyanate (IPDI); tris(4-isocyanato-phenyl)-methane; phosphoric acid tris-(4-isocyanato-phenyl ester); and thiophosphoric acid tris-(4-isocyanato-phenyl ester).

Examples of suitable compounds (for example, monomers or pre-polymers) containing two or more amine functional groups include, but are not limited to, hydrazine; ethylenediamine; 1,2-propylenediamine; 1,3-propylenediamine; 1-amino-3-methylaminopropane; 1,4-diaminobutane; N,N′-dimeth-1-ethylenediamine; 1,6-diaminohexane; 1,12-diaminododecane; 2,5-diamino-2,5-dimethylhexane; trimethyl-1,6-hexane-diamine; diethylenetriamine; N,N′,N″-trimethyldiethylenetriamine; triethylenetetraamine; tetraethylenepentamine; pentaethylenehexamine; and polyethyleneimine, having number average molecular weights of between 250 and 10,000; dipropylenetriamine; tripropylenetetraamine; bis-(3-aminopropyl)amine; bis-(3-aminopropyl)-methylamine; piperazine; 1,4-diaminocyclohexane; isophoronediamine; N-cyclohexyl-1,3-propanediamine; bis-(4-amino-cyclohexyl)methane; bis-(4-amino-3-methyl-cyclohexyl)-methane; bisaminomethyltricyclodecane (TCD-diamine); o-, m- and p-phenylenediamine; 1,2-diamino-3-methylbenzene; 1,3-diamino-4-methylbenzene(2,4-diaminotoluene); 1,3-bisaminomethyl-4,6-dimethylbenzene; 2,4- and 2,6-diamino-3,5-diethyltoluene; 1,4- and 1,6-diaminonaphthalene; 1,8- and 2,7-diaminonaphthalene; bis-(4-amino-phenyl)-methane; polymethylenepolyphenylamine; 2,2-bis-(4-aminophenyl)-propane; 4,4′-oxybisaniline; 1,4-butanediol bis-(3-aminopropyl ether); 2-(2-aminoethylamino)ethanol; 2,6-diamino-hexanoic acid; liquid polybutadienes or acrylonitrile/butadiene copolymers which contain amino groups and have number average molecular weights of between 500 and 10,000; and polyethers containing amino groups.

Examples of suitable compounds (for example, monomers or pre-polymers) containing two or more hydroxyl functional groups include, but are not limited to, polyether polyols, polyester polyols, polycaprolactone polyols, polycarbonate polyols, and any combinations of the listed items.

In some cases, powdered particles of a polyurea thickening agent can be mixed with a hydrocarbon-based carrier fluid (for example, diesel, mineral oil, kerosene, isoparaffin, a cyclic alkane (for example, cycloparaffin), a fatty acid, an ester, an ether, an alcohol, an amine, an amide, an imide, an unsaturated hydrocarbon such as an alkene, or a combination of one or more such carrier fluids) to form a slurry. When the slurry is subjected to temperatures of about 150° F., the polyurea can thicken to form a shear-sensitive gel. In some cases, the density of the slurry can be reduced by mixing the slurry with microbubbles. When injected into an oil well, the slurry can float uphole, to the top of the oil column in the annulus. The thickening reaction triggered by heating the polyurea can lead to formation of a gel that acts as a packer to separate the ESP from the downhole hydrocarbon environment. Further, the gelled polyurea packer can be shear-thinning in nature, thus facilitating downhole pipe movement.

### EXAMPLES

### Example 1—Lightweight Resin Composite

To generate a low-density composite, 20 grams (g) of 3M™ HGS19K46 Glass Bubbles (density: 0.46 grams per cubic centimeter (g/cm³); particle size range: 20-29 microns) was added to a beaker and heated to 450° F. while mixing at 600 revolutions per minute (rpm) with an overhead mixer. Once at temperature, 20 g of the PLENCO® 14542 resin (a phenol-formaldehyde novolac thermoset resin from Plastics Engineering Company; Sheboygan, Wis.) was mixed in at a shear rate of 1900 rpm for one minute. Three (3) g of a hyxamethylenetetramine curing agent (Hexion Inc.; Columbus, Ohio) was then added. After mixing, the composition turned yellow and hardened considerably. A ratio of resin:curing agent ranging from about 2:1 to about 1:2 (for example, a 1:1 ratio) typically is used, although it is noted that the ratio of resin:curing agent may depend on the molecular weight, composition, and formulations (for example, percentage of solvent or other additives) of the resin and curing agent.

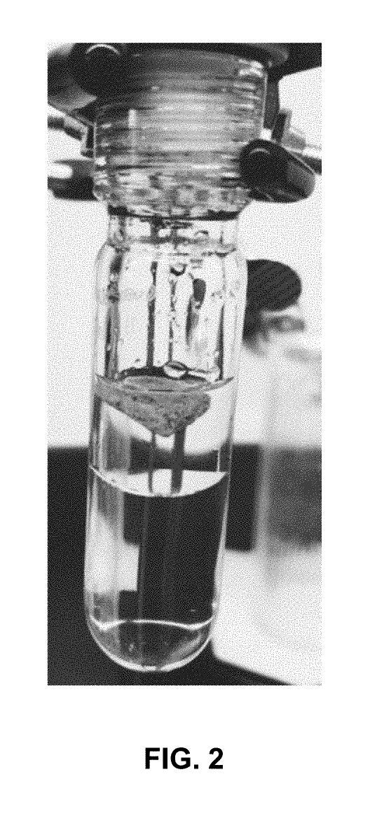

To determine whether the low-density composite could float to the top of a hexanes layer, the following experiment was conducted. Ten milliliters (10 mL) of tap water and 10 mL of hexanes were mixed into a test tube, and the pre-made lightweight composite made from PLENCO® resin was added into this mixture. Even after viscous shaking, the yellow composite floated to the top hexanes layer (FIG. 2).

### Example 2—Oil-Swellable Composite

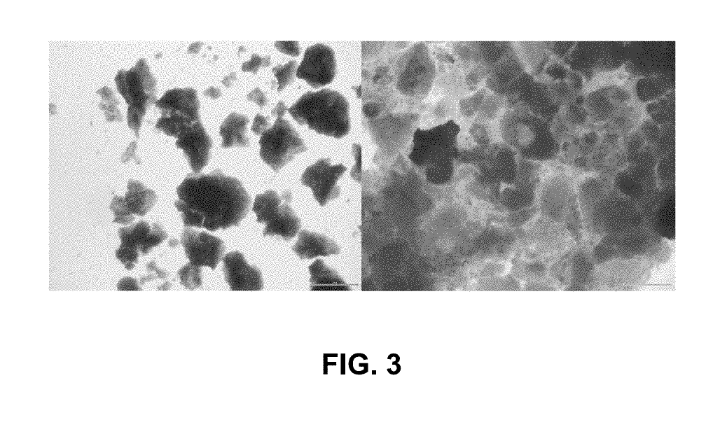

To test the effectiveness of using an oil-swellable material, PLIOLITE DF01® (a vinyl toluene acrylic copolymer resin gel from Omnova Solutions; Fairlawn, Ohio) was mixed with diesel and heated to 200° F. PLIOLITE DF01® is a polymer that absorbs oil and expands at elevated temperature. FIG. 3 shows microscopic images of PLIOLITE® before (left panel) and after (right panel) expansion. The expanded polymer formed a gel.

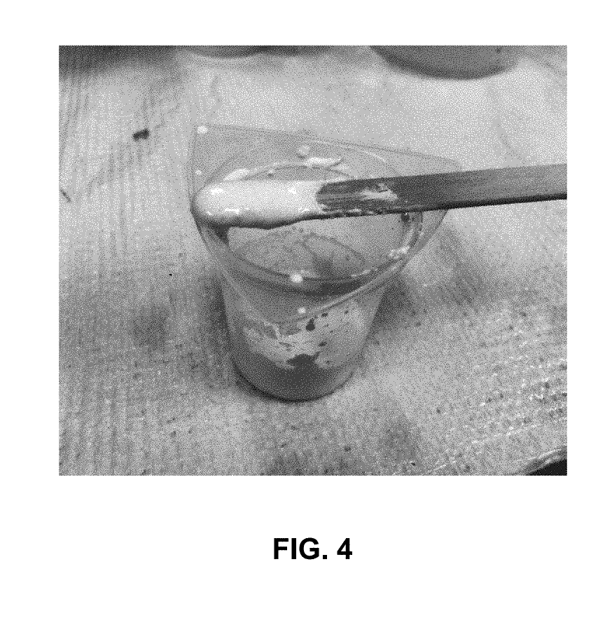

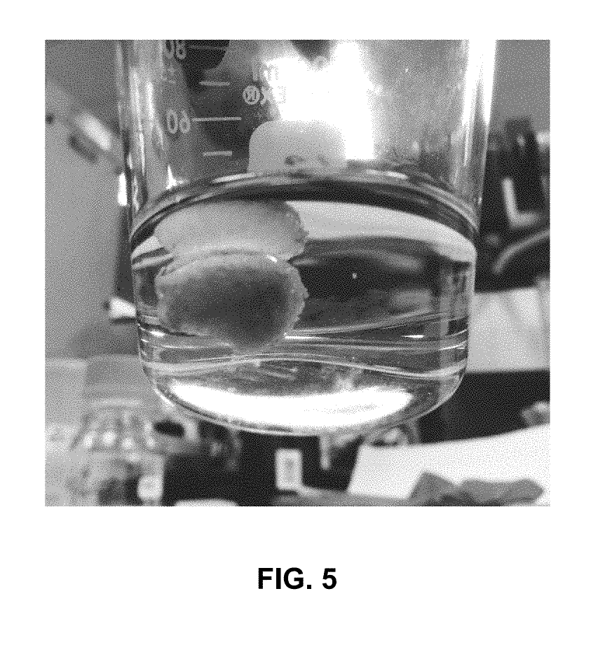

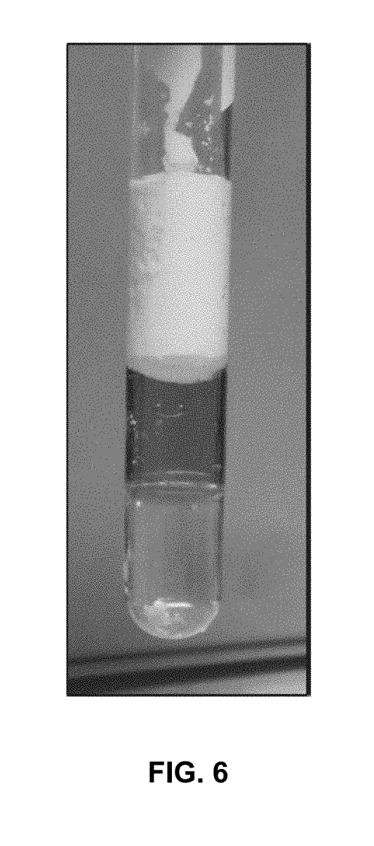

To reduce the composite density so that it was lower than the density of crude oil, the polymer (non-expanded) was mixed with water and micro glass bubbles to generate a paste, as shown in FIG. 4. The viscosity of the paste was controlled by the amount of water added, and the paste was able to be pumped through tubing. The density of the paste was calculated as the sum of each component's density multiplied by its volume fraction in the bulk paste, divided by the bulk past volume. The density of the composite paste was lighter than that of diesel, ranging from 0.58 grams per milliliter (g/ml) to 0.75 g/ml depending on the ratio of polymer to micro glass bubbles. FIG. 5 shows a drop of the composite floating on the surface of diesel. The composite on top of the diesel was then heated to 200° F. in an oven to generate a chemical system that sealed the fluids beneath, as shown in FIG. 6.

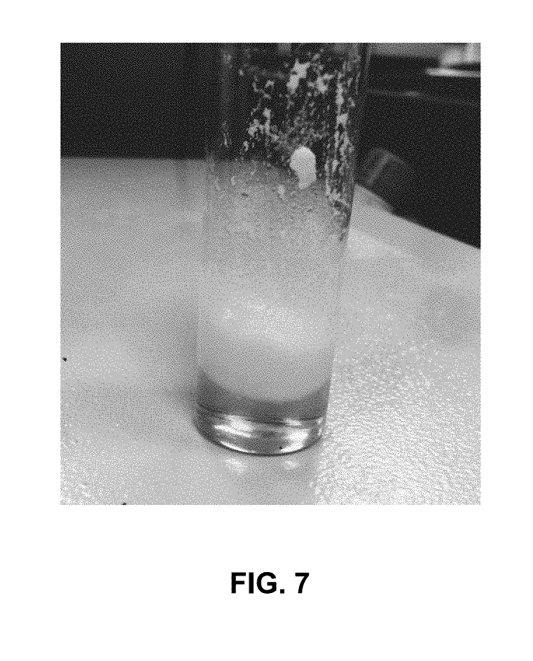

Additional studies were conducted using EXPANCEL® (AkzoNobel) to lower the density of the PLIOLITE DF01® polymer. EXPANCEL® is a material of hollow polymer bubbles with very low density. A mixture of 3 g EXPANCEL® DE and 1 g PLIOLITE DF01® in 4 cubic centimeters (cc) of water was less dense than diesel, and after heating to 95° Celsius (C), the mixture formed a seal over the diesel, as shown in FIG. 7.

### Other Embodiments

It is to be understood that while the present application has been described in conjunction with the detailed description, the foregoing description is intended to illustrate and not limit the scope of the present application, which is defined by the scope of the appended claims. Other aspects, advantages, and modifications are within the scope of the following claims.

1. A method for making a low-density gel or composite, comprising combining a polymeric material and a low-density material to form a mixture, and exposing the mixture to conditions sufficient to cause the mixture to form a low-density gel or composite that is impermeable to crude oil.

2. The method of claim 1, wherein the density of the gel or composite is less than 790 kg/m³.

3. The method of claim 1, wherein the polymeric material comprises an oil-swellable elastomer, and wherein the exposing comprises contacting the mixture with oil.

4-6. (canceled)

7. The method of claim 1, wherein the mixture further comprises a foaming surfactant.

8. (canceled)

9. The method of claim 1, wherein the polymeric material comprises a crosslinkable polymer, and wherein the exposing comprises contacting the mixture with a crosslinking agent or exposing the mixture to heat to generate a crosslinked polymer.

10-11. (canceled)

12. The method of claim 1, wherein the polymeric material comprises a curable resin, and wherein the exposing comprises contacting the curable resin with a curing agent.

13. (canceled)

14. The method of claim 1, wherein the polymeric material comprises an oil-soluble polymer, and wherein the exposing comprises contacting the mixture with oil.

15-16. (canceled)

17. The method of claim 1, wherein the polymeric material comprises polyurea or a polyurea-based agent, and wherein the exposing comprises exposing the mixture to a temperature of about 150° F.

18. The method of claim 1, wherein the low-density material comprises rigid spheres.

19-20. (canceled)

21. The method of claim 1, wherein the polymeric material is fused to or coated on the outer surface of the low-density material.

22. A method for making a low-density gel or composite, comprising combining colloidal nanosilica and a low-density material to form a mixture, and exposing the mixture to salt or to a pH less than 7, such that the mixture to forms a gel or composite.

23. The method of claim 22, wherein the density of the gel or composite is less than 790 kg/m³.

24. The method of claim 22, wherein the low-density rigid spheres comprise microbubbles.

25. (canceled)

26. The method of claim 22, wherein the colloidal nanosilica is fused to or coated on the outer surface of the low-density rigid spheres.

27. The method of claim 1, comprising placing the polymeric material and low density material mixture into an oil well at or about the location of an electrical component of a packer penetrator within the well, and exposing the mixture to conditions sufficient to cause the mixture to form a gel or composite that separates the electrical component from oil in the well.

28-46. (canceled)

47. The method of claim 22, comprising placing the colloidal nanosilica and low density material mixture into an oil well at or about the location of an electrical component of a packer penetrator, and exposing the mixture to salt or a pH less than 7 such that it forms a gel or composite that separates the electrical component from oil in the well.

48-53. (canceled)

54. A composition comprising:
colloidal silica;
an activator; and
hollow glass microspheres (HGMs).

55. The composition of claim 54, wherein the density of the composition is less than 790 kg/m³.

56. The composition of claim 54, wherein the colloidal silica comprises a nanosilica.

57. The composition of claim 54, wherein the activator comprises a salt or a low pH solution.

58-64. (canceled)
